(19) United States
(12) Patent Application Publication
(10) Pub. No.: US 2025/0262669 A1
(43) Pub. Date: Aug. 21, 2025

(54) High silicon electrical steel alloys using directed energy deposition

(71) Applicant: National Technology & Engineering Solutions of Sandia, LLC, Albuquerque, NM (US)

(72) Inventors: Andrew Kustas, Elizabeth, CO (US); Jesse Adamczyk, Albuquerque, NM (US); Donald F. Susan, Albuquerque, NM (US); Todd Monson, Albuquerque, NM (US); Erin Jenna Barrick, Albuquerque, NM (US); Jonathan Wesley Pegues, Albuquerque, NM (US)

(21) Appl. No.: 18/444,882

(22) Filed: Feb. 19, 2024

(51) Int. Cl. B22F 10/28; B22F 10/64; B33Y 10/00; B33Y 40/20; B33Y 70/00; C22C 38/02; H01F 1/147

(52) U.S. Cl. CPC B22F 10/28; B22F 10/64; B33Y 10/00; B33Y 40/20; B33Y 70/00; C22C 38/02; H01F 1/14775; B22F 2301/35; B22F 2998/10; B22F 2999/00; C22C 2202/02

(57) ABSTRACT

Additive manufacturing enables near-net-shape fabrication of high silicon electrical steel alloys. The wide array of process conditions provides additive manufacturing with increased flexibility, enabling control over the microstructure and mechanical properties, compared to conventional rolling and sheet fabrication. As an example of the invention, microstructures and magnetic properties of ring-shaped Fe—Si alloys produced using concentric and cross-hatch tool paths on a laser beam-directed energy deposition additive manufacturing system were evaluated. Build strategies and thermal treatments can be selected to enable the use additively manufactured Fe—Si alloys in electrical power conversion applications.

### FEDERALLY SPONSORED RESEARCH AND DEVELOPMENT

This invention was made with Government support under Contract No. DE-NA0003525 awarded by the United States Department of Energy/National Nuclear Security Administration. The Government has certain rights in the invention.

### STATEMENT REGARDING PRIOR DISCLOSURES BY THE INVENTOR OR A JOINT INVENTOR

The following disclosure is submitted under 35 U.S.C. 102 (b) (1) (A): Jesse M. Adamczyk, Sarah E. Birchall, Ethan T. Rothermel, Shaun R. Whetten, Erin J. Barrick, Charles J. Pearce, Robert E. Delaney, Jonathan W. Pegues, Kyle L. Johnson, Donald F. Susan, Todd C. Monson, and Andrew B. Kustas, “Characterization of Fe—6Si Soft Magnetic Ally Produced by Laser-Directed Energy Deposition Additive Manufacturing,” JOM, published online: 8 Dec. 2023. The subject matter of this disclosure was conceived of or invented by the inventors named in this application.

### BACKGROUND OF THE INVENTION

Fe—Si (i.e., electrical steel) alloys possess favorable electromagnetic properties, such as high magnetic permeability/saturation induction, low coercivity/core loss, and increased electrical resistivity, that are ideal for electric motor and transformer applications. See R. M. Bozorth, Ferromagnetism (Van Nostrand, New York, 1951). The addition of Si into Fe both stabilizes the ferrite (BCC) structure and enhances the electromagnetic properties, with peak alloy performance defined by the highest permeability, minimum core loss, and near-zero magnetostriction at a high-Si content of 6.5 wt. %. See A. B. Kustas et al., Metall. Mater. Trans. A 47, 3095 (2016); and A. B. Kustas et al., J. Mater. Res. 31, 3930 (2016). Despite improving energy efficiency of electromagnetic devices through the use of high-Si content electrical steels, widespread commercial adoption of these alloys is inhibited by poor material ductility and workability, making conventional manufacturing via sequential steps of casting and thermomechanical deformation (e.g., forging or flat sheet rolling) impractical.

A majority of electromagnetic devices are restricted to the use of less efficient, low-Si content alloys with compositions of 1-4 wt. % Si. Substantial effort has been focused on developing techniques to produce bulk forms of traditionally brittle soft magnetic alloys, such as hot forging, thin-film deposition, powder rolling, and mechanical alloying. See J. Xie et al., Intermetallics 23, 20 (2012); E. Yun et al., IEEE Trans. Magn. 32, 4535 (1996); C. Platt et al., J. Appl. Phys. 88, 2058 (2000); G. Tian and X. Bi, J. Alloys Compd. 502, 1 (2010); Y. Shimada and H. Kojima, J. Appl. Phys. 47, 4156 (1976); N. Fenineche et al., Mater. Lett. 58, 1797 (2004); R. Li et al., J. Magn. Magn. Mater. 281, 135 (2004); M. Abdellaoui et al., J. Alloys Compd. 198, 155 (1993); and C. Kuhrt and L. Schultz, J. Appl. Phys. 73, 6588 (1993). While these techniques have some advantages over conventional deformation processing strategies, they are largely limited to small volumes of material that remain brittle. One exception to this generalization is a high-Si content electrical steel sheet produced by JFE Corporation via a chemical vapor deposition siliconizing process. However, this approach is thickness-dependent due to a reliance on diffusion of Si at high temperatures; the process has yet to replace the more ubiquitous low-Si content electrical steel sheet products produced via conventional rolling processes. See H. Haiji et al., J. Magn. Magn. Mater. 160, 109 (1996); Y. Takada et al., J. Appl. Phys. 64, 5367 (1988); and M. Abe et al., J. Mater. Eng. 11, 109 (1989). Therefore, developing manufacturing approaches that enable greater efficiency from electrical steel alloys remains a target for next-generation energy systems, especially to address global decarbonization initiatives. For instance, processing and integration of optimal magnetic alloy compositions, such as high-Si content electrical steels, in electromagnetic devices like motors and transformers is predicted to enable energy savings in excess of 10,000 gigawatt-hours annually. See U.S. Dept. of Energy, High-Silicon Steel Sheet by Single Stage Shear-Based Processing, US Government Technical Report (2017); and U.S. Dept. of Energy, Development of New Steel Alloy to Reduce Core Losses in Electric Motors, US Government Technical Report (2017).

Additive manufacturing (AM), especially laser powder bed fusion (L-PBF), has emerged as a strong candidate for producing bulk geometries from traditionally brittle soft magnetic alloys, such as high-Si content electrical steels, Fe—Co alloys, and Fe—Ni alloys. See M. Garibaldi et al., Acta Mater. 110, 207 (2016); A. Plotkowski et al., Mater. Des. 194, 108894 (2020); T. F. Babuska et al., Acta Mater. 180, 149 (2019); M. Garibaldi et al., Scr. Mater. 142, 121 (2018); A. Plotkowski et al., Addit. Manuf. 29, 100781 (2019); A. B. Kustas et al., Addit. Manuf. 21, 41 (2018); T. Riipinen et al., Rapid Prototyp. J. 25, 699 (2019); J. Geng et al., JOM 68, 1972 (2016); W. Everhart and J. Newkirk, Appl. Sci. 9, 3701 (2019); S. Firdosy et al., Adv. Eng. Mater. 24, 2100931 (2022); C. Mikler et al., Mater. Lett. 199, 88 (2017); and C. Mikler et al., Mater. Lett. 192, 9 (2017). The principal advantage afforded by AM processing for these materials is the characteristic thermal history associated with rapid solidification during layer-wise processing. AM can avoid equilibrium order-disorder phase transitions responsible for brittle behavior in soft magnetic material. See I. Baker, Mater. Sci. Eng. A 192, 1 (1995); A. B. Kustas et al., Addit. Manuf. 28, 772 (2019); J. Lemke et al., J. Alloys Compd. 722, 293 (2017); and M. Nartu et al., J. Alloys Compd. 861, 157998 (2021). For Fe—Si alloys, equilibrium phase transformations include transitions from disordered BCC to ordered B2 and/or DO3 phases, which are known to impede dislocation accommodation mechanisms leading to near-zero tensile ductility for high-Si content electrical steels. See G. E. Lakso and M. Marcinkowski, Metall. Mater. Trans. B 5, 839 (1974); and G. Ouyang et al., J. Magn. Magn. Mater. 481, 234 (2019). Furthermore, near-net-shape part geometries built by AM reduce the need for manufacturing by deformation processes that are prone to cracking or failure in brittle alloys. Thus, AM enables processing of high-silicon alloys in near-net-shape bulk form. AM processing routes also create opportunities to tailor local microstructures and improve performance to a greater extent than conventional manufacturing, which is enticing for next-generation electromagnetic device designs. See A. B. Kustas et al., JOM 1-23 (2022); T. Pham et al., Energies 14, 283 (2021); and M. Garibaldi et al., J. Mech. Des. 141, 071401 (2019).

### SUMMARY OF THE INVENTION

The present invention is directed to a method for laser-beam directed energy deposition of a high-silicon electric steel part, comprising depositing a powder stream of a high-silicon content Fe—Si alloy on a substrate, simultaneously melting or sintering the deposited powder using a focused laser beam coincident with the powder stream, scanning the coincident laser/powder streams relative to the substrate according to a scan strategy to print a layer, and building the three-dimensional high-silicon electric steel part via layer-by-layer printing of successive layers of high-silicon content Fe—Si alloy. The high-silicon content Fe—Si alloy can comprise greater than 4 wt. % silicon and, preferably greater than 6 wt. % silicon. The method can further comprise heat treating the three-dimensional high-silicon electric steel part at an annealing temperature. The scan strategy can be configured to minimize residual stresses in the three-dimensional high-silicon electric steel part. The high-silicon electric steel can have a hardness greater than 360 HV. The high-silicon electric steel can have a coercivity less than 50 A/m. The high-silicon electric steel can have a saturation magnetization greater than 1.5 Tesla. The method can further comprise printing a layer of non-conductive material between successive layers of high-silicon content Fe—Si alloy to provide a stacked lamination.

The invention enables laser beam-directed energy deposition additive manufacturing of high-Si content electrical steel alloys in a bulk form that are otherwise impractical to manufacture using conventional thermomechanical processes. Additive manufacturing is therefore an enabling, rather than a limiting, approach toward developing next-generation soft magnetic alloys for electromagnetic applications. However, tradeoffs in alloy structure-property relationships exist. Most critically, scan path dependent mechanical behavior highlights the flexibility of additive manufacturing to overcome challenges associated with the manufacturing of traditionally brittle alloys. For example, concentric- and cross-hatch-built geometries were found to result in differing characteristic microstructures that evolved following various heat treatments, ultimately leading to exceptionally coarse grain sizes. Thermal finite element analysis simulations was used to understand cracking in the concentric-built samples, with residual tensile stresses in the concentric build calculated to be greater than the tensile strength of the Fe—6Si alloy. Magnetic properties, including full-field induction, coercivity, permeability, and core loss, were characterized for specimens as a function of heat-treatment temperature and testing frequency. The magnetic performance and microhardness properties were found to be competitive to existing state-of-the-art electrical steel alloys without process optimization, suggesting numerous opportunities to further improve performance. Additively manufactured functional materials have great potential for improving power conversion efficiency and can enable next generation designs of electromagnetic devices, including transformers and electric motors.

### BRIEF DESCRIPTION OF THE DRAWINGS

The detailed description will refer to the following drawings, wherein like elements are referred to by like numbers.

FIG. 1 is a schematic illustration of a laser engineered net shaping (LENS) system, showing processing parameters.

FIG. 2a is a schematic illustration of a ring sample showing the tool path for a concentric build geometry. FIG. 2b shows the tool path for a cross-hatch build geometry with a 90° rotation after each layer. FIG. 2c is a cut-away view schematic illustration of the ring sample showing the planar and cross-sectional view perspectives used to image the microstructure.

FIGS. 3a, 3c, 3e, and 3g are planar-view micrographs of concentric-built samples and FIGS. 3b, 3d, 3f, and 3h are planar-view micrographs of cross-hatch-built samples, showing microstructures that strongly depend on scan path geometry and annealing condition. Concentric samples exhibit an elongated microstructure and the presence of cracks after annealing at 700° C. or greater. Microstructure of the cross-hatch samples shows little directionality due to the difference in scan path. For both concentric and cross-hatch samples, annealing at 1200° C. removes all microstructural features.

FIGS. 4a, 4c, 4e, and 4g are cross-sectional micrographs of concentric-built samples and FIGS. 4b, 4d, 4f, and 4h are cross-sectional micrographs of cross-hatch-built samples, showing few distinguishing features as a result of the differing scan path geometries. Weld pool marks due to the AM process are evident in the 500-700° C. micrographs; however, annealing at 900-1200° C. completely removes any evidence that this material was produced by additive manufacturing.

FIGS. 5a, 5c, 5e, and 5g are planar-view electron backscatter diffraction (EBSD) invert pole-figure (IVPF) maps and pole figures of concentric-built samples and FIGS. 5b, 5d, 5f, and 5h are EBSD IVPF maps of cross-hatch-built samples. Concentric samples annealed between 500-900° C. show elongated grains due to solidification in the circumferential direction. Cross-hatch samples show a microstructure zig-zagging tool path. At 1200° C., cracking in the concentric sample prevents further grain growth; however, annealing of the cross-hatch grows grains into a quasi-single crystal.

FIG. 6 shows residual stress in as-built concentric and cross-hatch rings calculated by thermal finite element analysis simulations. The concentric scan path creates a high volume of tensile residual stresses at ˜500 MPa. The cross-hatch material exhibits a low volume of residual stresses, peaking close to ˜400 but only at select areas of the inner diameter.

FIG. 7a is a graph of induction field versus temperature, showing that for both concentric and cross-hatch samples, quasistatic measurements of saturation are greater than the AC saturation measurements. FIG. 7b is a graph of coercivity versus temperature showing that, due to eddy current effects, coercivity of samples measured at 60 Hz is significantly greater than the quasistatic coercivities. FIG. 7c is a graph of permeability versus temperature showing that, like coercivity, quasistatic permeability is found to be significantly greater than the AC permeability. Cracking in the sample may cause a drop in the 1200° C. concentric permeability. Saturation and permeability values from commercial non-oriented and high-Si steels are included for reference.

FIG. 8 is a graph of core loss of concentric and cross-hatch Fe—6Si rings measured at 600 Hz. Minimal changes in core loss occur as a function of anneal temperature and build strategy.

FIG. 9 is a graph of Vickers hardness of the concentric and cross-hatch Fe—6Si samples, showing limited dependence on anneal temperatures. In comparison to mid-grade 1-2 wt. % Si electrical steels (150-220 HV), these 6 wt. % Si steels have greater hardness that will reduce magnetostrictive losses.

### DETAILED DESCRIPTION OF THE INVENTION

According to the present invention, laser beam-directed energy deposition (LB-DED), for example via a laser engineered net shaping (LENS) process, provides a viable route for producing bulk geometries of high Si-content Fe—Si alloys. LB-DED enables processing of bulk near-net-shape geometries of the soft magnetic alloy wherein the extent of macroscopic defects/cracking is directly influenced by the laser scan strategy. As an example of the invention, microstructural results for the AM Fe—6Si soft magnetic alloy were examined as a function of print strategy and annealing temperature. Thermal finite element analysis (FEA) simulations indicate how scan strategies can have a major influence the residual stress of LB-DED parts. Quasistatic and frequency dependent magnetic properties, along with mechanical hardness, were characterized for samples and described in the context of AM processing and postprocessing annealing conditions. The invention builds upon growing efforts for accelerating AM processing of soft magnetic alloys and demonstrates another case in which AM techniques can be enabling, rather than limiting, for developing high-performance alloys. See A. B. Kustas et al., JOM 1-23 (2022); T. Pham et al., Energies 14, 283 (2021); T. N. Lamichhane et al., Mater. Today Phys. 15, 100255 (2020); V. Chaudhary et al., Prog. Mater. Sci. 114, 100688 (2020); E. Perigo et al., Addit. Manuf. 30, 100870 (2019); and P. Ohodnickin and G. Spanos, Research and Technological Development in the Additive Manufacturing of Energy-Related Functional Materials, TMS, Pittsburgh, PA.

### Laser Engineered Net Shaping

Directed energy deposition refers to an additive manufacturing process wherein focused thermal energy is used to fuse materials layer-by-layer via melting as they are being deposited. In general, the heat input can be a laser, electron beam, or plasma arc. The material feedstock can be a metal powder or wire. Deposition typically occurs either under inert gas or in a vacuum.

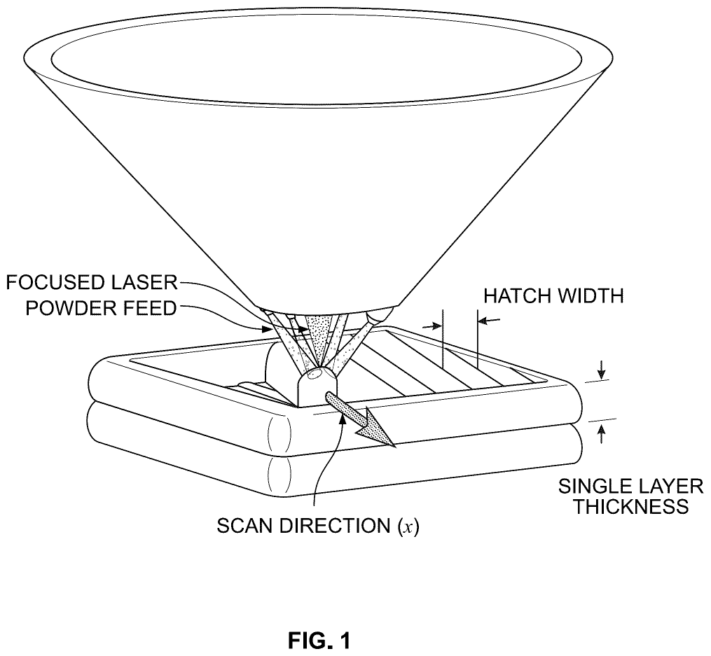

As shown in FIG. 1, LENS is a powder-fed LB-DED AM process that uses layer-by-layer powder deposition and simultaneous melting/sintering of the deposited powder to build a three-dimensional (3D) part or object. The LENS process uses a focused laser beam and coaxially supplied fluidized powder streams to deposit material onto a substrate. Multiple powder streams are oriented to converge to a point coincident with the focal plane of a high-powered laser. The laser melts the material surface, and the powder is consumed in the melt pool. By rastering or scanning the combined laser/powder streams horizontally relative to the substrate according to a scan strategy to print a layer and moving the deposition head vertically as each layer is completed to print a new layer on the previously printed layer, 3D parts can be built up via a layer-by-layer printing process. LENS is similar to L-PBF, except with LENS the metal powder is supplied only where material is being added to the part at that moment and the heat source (laser, etc.) typically remains stationary while the build volume is in motion according to a 3D part scan strategy.

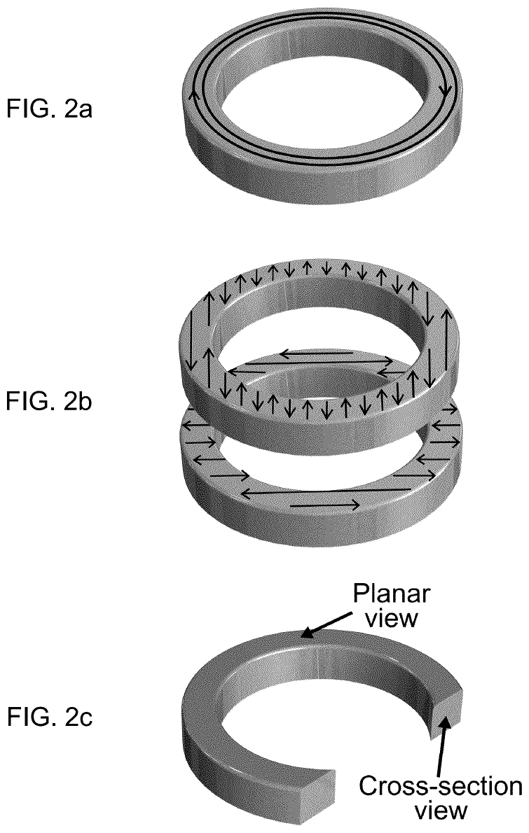

As an example, hollow cylindrical samples with 27.9-mm outer diameter (OD) and 17.8-mm inner diameter (ID) were additively manufactured from gas-atomized, pre-alloyed Fe—6Si powder with a nominal 45-μm to 90-μm particle size distribution. An open-architecture LENS system comprising a 3-axis Tormach CNC 770 (Tormach, Waunakee, WI, USA) with a spindle-mounted YLS-2000 laser operating at a 1064-nm wavelength housed in a controlled atmosphere glovebox was used to build the samples. Additional details for the AM system are available in Kustas et al. See A. B. Kustas et al., Addit. Manuf. 21, 41 (2018); and A. B. Kustas et al., Addit. Manuf. 28, 772 (2019). The bulk hollow cylinders were constructed utilizing either concentric or cross-hatch laser scan strategies, as detailed in FIGS. 2a and 2b, respectively, using laser powers of 350-400 W and an approximate layer thickness of 250 μm. For the concentric build, the cylinder in-fill was completed by depositing beads in successive rings spaced by the approximate hatch width (h=0.8 mm). The concentric path begins at the midpoint between the inner and outer diameters and builds inwards. Once the inner diameter is reached, the tool head jumps to the midpoint between the inner and outer diameters and builds outwards towards the outer diameter. Concentric builds were made with a laser velocity of 500 mm/min. The cross-hatch strategy employed a perimeter on the ID and OD, followed by a 180° infill pattern for each layer that was then rotated 90° relative to the previous layer. The perimeter utilized a speed of 420 mm/min, while the cross-hatch in-fill utilized a speed of 720 mm/min. Both processing strategies were iterated layer-by-layer until the desired cylinder height was achieved (˜20 mm).

### Sample Preparation

Quasi-static and frequency-based magnetic properties were measured from B-H ring specimens that were extracted from the hollow cylindrical builds via wire electrical discharge machining, with dimensions of 21 mm ID×25 mm OD×2 mm thickness, based on ASTM A773. See Standard Test Method for Direct Current Magnetic Properties of Low Coercivity Magnetic Materials Using Hysteresigraphs, ASTM International Standard (2010). Each ring had 60 primary and 60 secondary windings to measure the magnetic properties. Magnetic properties and hardness were measured on specimens in both the as-built and heat-treated conditions.

Post-processing heat treatment consisted of 500° C., 700° C., 900° C., and 1200° C. with 4-h isothermal hold times. The times and temperatures were selected based on prior literature and the physical metallurgy of electrical steels. See M. Garibaldi et al., Scr. Mater. 142, 121 (2018); and J. Lemke et al., J. Alloys Compd. 722, 293 (2017). Specifically, the 500° C. heat treatment coincides with the dual B2/DO3 equilibrium phase region, while 700° C. solely resides in B2. The 900° C. and 1200° C. conditions were well within the chemically disordered BCC region; the latter also represents the typical upper bound temperature limit for annealing conventional electrical steel sheets to, in select products, achieve abnormal grain growth. This is discussed in more detail later on. Heat treatments were conducted in a vacuum furnace maintained at 10⁻⁶ Torr (or lower) pressure with a furnace-controlled cooling rate of 2.3° C./min to minimize thermal shock and achieve equilibrium ordered phases. Microstructures of the specimens in both as-built and heat-treated conditions were characterized using light optical microscopy after metallographic preparation with grinding and polishing up to 0.04 μm with colloidal SiO₂. Etched samples were prepared using a % nital solution.

### Microstructure of AM Fe-6 wt. % Si Soft Magnetic Alloy

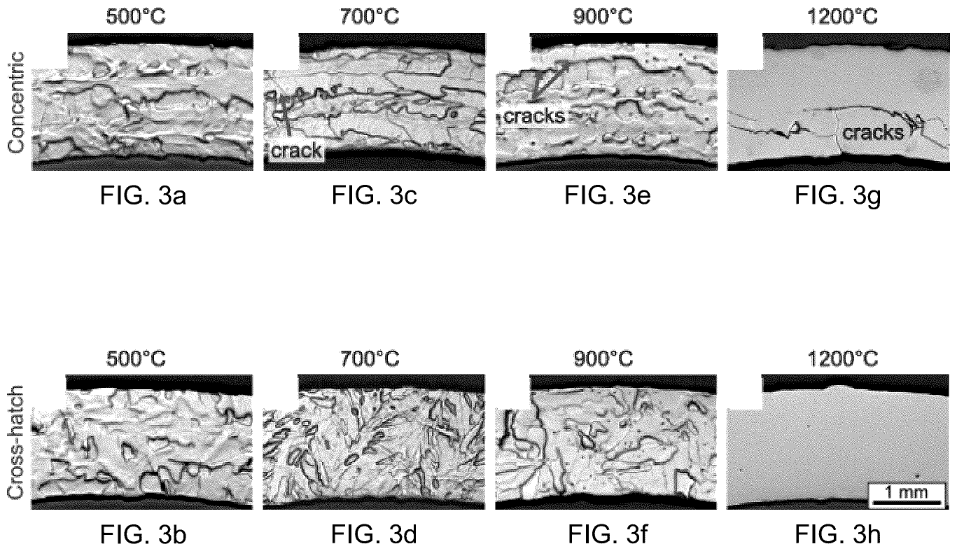

FIGS. 3a-3h shows micrographs of etched specimens across the full range of heat-treatment temperatures for both concentric and cross-hatch laser scan patterns in the planar view. The planar view perspective provides insights into the microstructure evolution, both grain size and morphology, within a given AM layer that results from heat treatment. Partially recrystallized microstructures were observed in samples heat-treated in the 500-700° C. range, characterized by a mixture of as-built columnar grains and comparably finer equiaxed grain morphologies. The as-built portion of the microstructure for the concentric build specimens (FIGS. 3a, 3c, 3e, and 3g) exhibited elongated grains in the direction of laser travel. These grains extended several hundred microns along the circumference of the ring, indicating the presence of an elongated melt pool that promotes directional solidification. Formation of elongated grains is also likely aided by epitaxial solidification off-parent (i.e., previously solidified) grains in the direction of the build. By comparison, the cross-hatch specimens (FIGS. 3b, 3d, 3f, and 3h) showed a grain structure without significant directionality, perhaps the result of shorter melt pool lengths and the bi-directional nature of the scan strategy. Following the 900° C. heat-treatment condition (FIGS. 3e and 3f), features of the as-built microstructure were less apparent, with evidence of grain coarsening and sharpening of grain boundaries. As-built features of the microstructures were entirely removed following the 1200° C. heat treatment, wherein extensive grain growth produced coarse (millimeter size) grains that were confined only by the geometry of the ring specimens (FIGS. 3g and 3h).

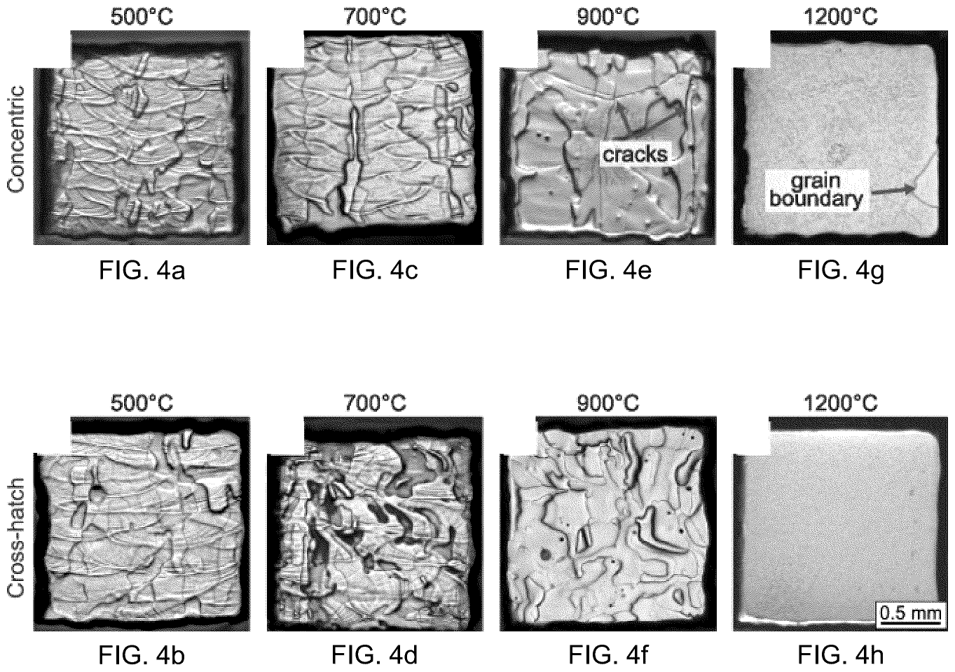

Cross-sectional views of the concentric and cross-hatch rings, shown in FIGS. 4a-4h, give a complementary perspective of the microstructure parallel to the build direction, encompassing several layers. At 500-700° C., the characteristic layered structure of layer-wise rapid solidification AM processing was observed for both build strategies (FIGS. 4a, 4c, 4b, and 4d). Evidence of epitaxial solidification was observed at these lower heat-treatment temperatures, typical for many alloys processed by metal AM and especially those that solidify with a single-phase microstructure. See A. Basak and S. Das, Annu. Rev. Mater. Res. 46, 125 (2016). At 900° C., significant grain growth occurred with homogenization, effectively removing the layer-wise melt pool pattern of the as-built microstructure toward a structure that is more typical of “wrought” electrical steel alloys. However, the concentric build (FIG. 4e) still showed an elongated grain structure aligned parallel to the build direction. These observations contrast with those for the cross-hatch build, which developed a relatively equiaxed microstructure following the 900° C. heat treatment (FIG. 4f). Complementing the planar view orientation results, substantial grain growth was observed for the 1200° C. heat-treatment condition (FIGS. 4g and 4h), wherein cross-sectional regions of the specimen revealed a coarse grain structure that was essentially single crystals confined just to the thickness of the specimen ring geometry. Geometric confinement of the grain structure therefore limited the extent of grain growth in the AM-processed ring specimens. Indeed, similar observations of coarse grain structures have been noted in prior literature for conventionally processed low-Si content electrical steels produced via rolling with subsequent high-temperature heat treatments. See S. Mishra et al., Acta Metall. 32, 2185 (1984); and N. P. Goss, Trans. ASM 23, 511 (1935). Referred to as grain-oriented electrical steel sheet, coarse microstructures develop through abnormal grain growth mechanisms that are similarly confined to the final sheet thickness. The abnormal grain growth also produces strong crystallographic textures, defined by the {110} planes parallel to the sheet surface and <100> directions parallel to the sheet length. This so-called Goss texture is well known for influencing magnetic anisotropy that uniquely benefits transformer applications.

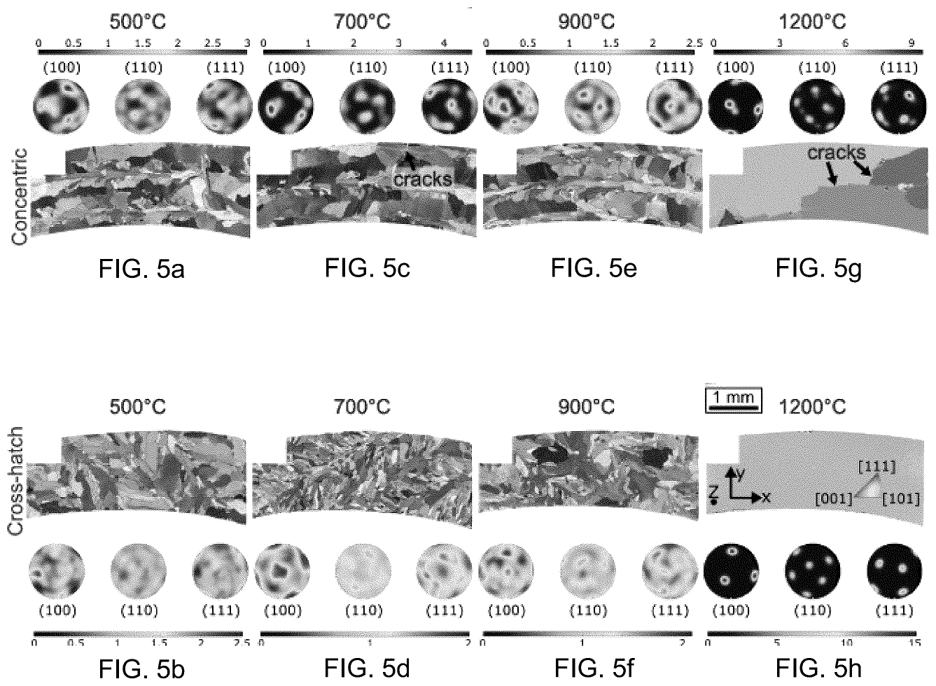

To further elucidate microstructure and crystallographic texture evolution in the samples as a function of heat treatment, electron backscatter diffraction (EBSD) analysis was also performed. The results are summarized in FIGS. 5a-5h, presented as inverse pole figure (IVPF) microstructure maps and the three principal (100), (110), and (111) pole figures. The IVPF maps reveal discrete grain boundaries that are obscured in the etched optical micrographs. Nonetheless, the EBSD analysis largely corroborated the findings from the optical images. Specifically, the concentric samples in FIGS. 5a, 5c, and 5e show a partially recrystallized microstructure with elongated grains that are remnants of the as-built structure, resulting from solidification in the circumferential direction. Similarly, cross-hatch samples (FIGS. 5b, 5d, and 5f) show partial recrystallization for the 500-900° C. heat treatment conditions. At 1200° C., rapid grain growth occurred in both build strategies that led to the formation of large, millimeter-size grains; the rings themselves were pseudo-single-crystal in this condition. Notably, isolated cracking in the concentric condition stunted grain growth, as shown in FIG. 5g.

Crystallographic textures measured from the EBSD analysis were fairly weak for the 500-900° C. conditions, with intensities ranging from 2 up to 4.5 multiples of a random distribution. Furthermore, the character of the textures was diffuse, with evidence of the typical <001> and <011> texture components, expected of AM, but these components were offset with respect to the build direction. The texture character of these samples likely developed as a result of growth competition between <001> and <011>-type fiber textures during solidification. In all conditions, no significant evidence of Goss-type components were measured with respect to the build direction. This is expected, since these texture components are hypothesized to originate from local shear-deformation near the roll-sheet interface during sheet processing and become the dominant texture following high-temperature heat treatment. See D. Dorner et al., J. Magn. Magn. Mater. 304, 183 (2006). AM processing generally leads to a fundamentally different residual stress and deformation state (i.e., dislocation density, substructure morphology, etc.) compared to rolling processes used for fabricating conventional electrical steel sheets. Therefore, recrystallization and abnormal grain growth mechanisms observed in conventional electrical steel may not occur in the same manner for AM material. Notably, since the microstructures are nearly pseudo-single-crystal in samples following the 1200° C. heat treatment, the textures are somewhat arbitrary (i.e., based on the machining/cutting plane). Therefore, coarse grain microstructures that are nearly single crystal can be intentionally developed via AM processing and heat treatment that are not achievable with conventional processing. The development of coarse grain structures in AM-processed electrical steel alloys may enable unique opportunities for electromagnetic devices. For example, single-crystal samples could be extracted from these AM builds for specific electromagnetic applications that benefit from the intrinsic crystal anisotropy.

In addition to the grain structure evolution, samples were also characterized in terms of overall build quality, as determined by the extent of defects in the microstructure. For both scan strategies, no macroscopic keyhole or lack-of-fusion porosity was observed, indicating high relative density was achieved. However, transgranular cracking in both the radial and azimuthal directions was observed for concentric samples heat-treated to 700° C. and above. Notably, the intensity of the cracking, based on crack length and width, increased for samples subjected to higher heat-treatment temperatures, with the greatest cracking intensity found for the 1200° C. condition. In contrast, cross-hatch samples showed no evidence of crack formation at any of the heat-treatment temperatures, presenting a notable dichotomy in quality between the two scan strategies. While the precise origin and mechanisms for crack formation in samples remains speculative, reasons are likely related to a combination of processing effects and intrinsic material workability issues that are exacerbated during heat treatment. For the former, thermal finite element analysis is provided below to help elucidate the role of layer-wise processing on thermal stress evolution and the role of processing on crack formation. For the latter, workability is defined here as the capacity of a material to accommodate plastic strains prior to crack formation. The addition of high Si concentrations (>6 wt. %) drastically reduces the tensile ductility and intrinsic workability of Fe to near-zero due to the formation of ordered intermetallic phases. See J. Lemke et al., J. Alloys Compd. 722, 293 (2017); and A. B. Kustas et al., J. Mater. Process. Technol. 257, 155 (2018).

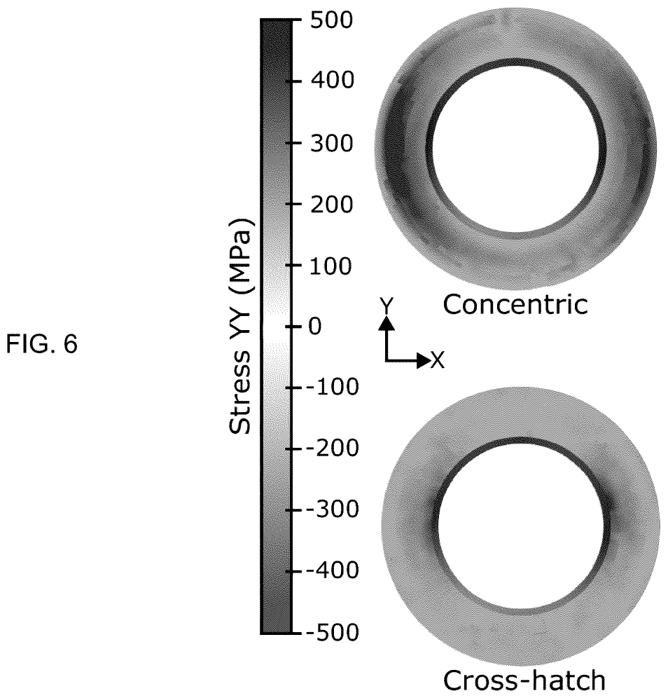

Compounding these intrinsic material workability issues are the thermal residual stresses that develop in parts during AM processing. The magnitude of these stresses are generally correlated to both layer-specific processing conditions, i.e., laser power and velocity, as well as the overall part build strategy/scan path. Samples produced herein were manufactured with constant layer-specific processing conditions; however, with distinctly different concentric and cross-hatch build strategies. Thermal finite element analysis modeling was conducted to elucidate the effects of scan strategy on residual stress evolution and the cracking seen in the Fe—6Si. FIG. 6 shows the predicted residual stress profile in a top-down orientation for the cross-hatch and concentric rings after the build. The residual stress is expressed in terms of the principal stresses that develop along the vertical direction (y-axis) in the cylinder cross-section. Modeling predicts that the concentric scan strategy leads to significant residual tensile stresses in the specimen along the circumference, with the magnitude of these stresses generally increasing radially from ID to OD and, in large regions, exceeding 500 MPa. This is especially noteworthy when considering that the strength-at-failure in tension for Fe—Si alloys near the 6 wt. % Si composition has been shown to be significantly lower than the residual stress in the concentrically-built cylinder. See M. Garibaldi, C. Gerada, R. Hague, PhD thesis, University of Nottingham (2018); and C. L. Cramer et al., Heliyon 5, e02804 (2019). Therefore, cracking in the concentrically-built ring is likely due to the tensile residual stress overcoming the tensile strength of the Fe—6Si material. The start and stop point of the concentric scan path creates a small region of localized compressive stress at the top of the ring; however, analysis of this region is forgone due to the small size and low magnitude of the stress. The cross-hatch-built ring exhibits lower tensile residual stress with the magnitude approaching 400 MPa at select regions near the ID. Lack of cracking in the cross-hatch-built rings is presumed to be a result of lower tensile stress values distributed across a small area. Additionally, the switch to a compressive stress at the circumference of the cross-hatch ring may help prevent cracking by competing against tensile stresses at the inner diameter. In agreement with the literature, these observations suggest that cracking susceptibility is significantly higher for rings built using the concentric scan strategy rather than the cross-hatch, providing an explanation for the cracking seen in FIGS. 3c, 3e, and 3g. See M. Salem et al., Addit. Manuf. 36, 101586 (2020). Choice of scan path pattern is thus identified as a critical process parameter for LB-DED-processed Fe—Si alloys due to the influence on cracking susceptibility in the intrinsically low ductility Fe—6Si alloy. See A. B. Kustas et al., J. Mater. Process. Technol. 257, 155 (2018). To emphasize, cracking was only observed in samples following heat treatments. It thus remains unclear if the cracks occur during deposition, only to propagate further during heat treatment due to the formation of ordered structures, or if heat treating alone leads to crack formation/propagation. Indeed, stress relief cracking is considered as a potential crack formation mechanism, but the literature highlights precipitation and segregation as typical key driving factors, neither of which are present in Fe—6Si. See J. Nawrocki et al., Weld. J. 82, 25-S (2003).

It is also worth highlighting that the absence of cracking in the cross-hatch samples illustrates the flexibility of AM to construct geometrically and compositionally identical components with entirely different mechanical responses. The scan strategy can be informed by FEA modeling in order to minimize residual residual stresses and cracking. These results suggest that process design tools will need to consider cracking susceptibility criteria to enable production of defect-free bulk components from traditionally brittle alloys. In this case, it is likely that shorter lengths of each linear cross-hatch motion reduced residual stresses in the AM-processed cylinders. See J. Capek et al., Mater. Des. 221, 110983 (2022). Notably, cracking has also been observed in L-PBF processing of Fe-6.5 wt. % Si, suggesting poor material workability. See M. Garibaldi et al., Acta Mater. 110, 207 (2016).

### Magnetic Properties of AM Fe—6Si Soft Magnetic Alloy

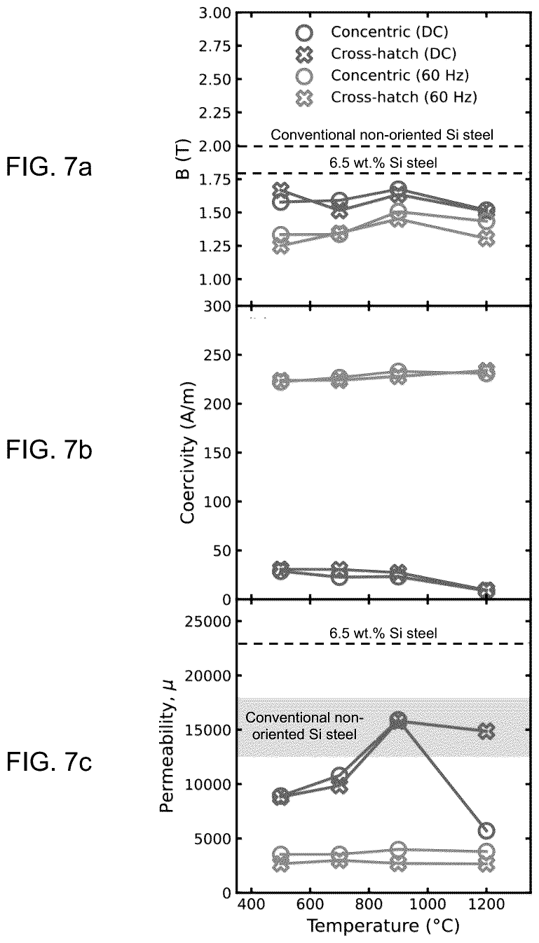

A summary of the full-field induction, coercivity, and permeability magnetic properties for the cross-hatch and concentric scan strategies are plotted in FIGS. 7a-7c, respectively, as a function of heat treatment and temperature for both quasistatic and 60-Hz testing frequencies. As expected, the alloy specimens from both scan strategies show a generally ‘harder’ magnetic response for the 60-Hz frequency testing conditions, due to the development of eddy currents. At 60 Hz, the full-field induction and permeability are reduced while the coercivity is greater in comparison to the quasistatic properties. These trends with frequency persisted across the various heat-treatment temperatures. In particular, FIG. 7a shows the extent by which the quasistatic full-field induction values are greater than the AC (60 Hz) measurements, with values ranging from approximately 1.6 T to 1.75 T for the former and from 1.25 to 1.5 T for the latter. Indeed, the AC hysteresis loops (not shown) become increasingly ellipsoidal with increased frequency in comparison to their quasistatic counterparts. For a given testing frequency across the heat-treatment temperatures, the full-field induction values showed little to no dependence; it is expected that saturation induction is a structure-insensitive property and solely dictated by composition.

FIG. 7b shows the relatively drastic effect of testing frequency on coercivity, wherein values for quasistatic measurements ranged from approximately 10 A/m to 30 A/m, while eddy currents cause the 60-Hz values to increase by an order of magnitude across the entire annealing temperature range. Notably, the coercivity, determined from quasistatic measurements for both build strategies, was found to slightly (near-monotonically) decrease with increased annealing temperature, with the largest decrease observed between the 900° C. and 1200° C. conditions. These trends align with the expectations for grain structure evolution in the Fe—Si samples, wherein grain size at the lower heat treatment temperatures was notionally constant at approximately 0.2 mm in diameter. Significant grain growth was only observed following the 1200° C. condition, where the grain size is on the order of several millimeters. Observations here generally align with the work by Herzer for an empirical relationship between grain size and coercivity, described by a linear 1/D (D=grain size) relationship between grain size and coercivity. See G. Herzer, IEEE Trans. Magn. 26, 1397 (1990). Notably, the coercivity decrease in FIG. 7b is also likely influenced, to a lesser extent, by an overall reduction in lattice strain and dislocation density inherited from AM processing that otherwise impedes magnetic domain wall motion. See E. Della Torre, J. Phys. Colloq. 49, C8-1909 (1988). In contrast to the quasistatic results, coercivity slightly increases with annealing temperature. These trends may be attributed to an increased eddy current loss caused by a reduction in electrical resistivity associated with annealing and the removal of structural defects, such as vacancies and dislocations. Nonetheless, these quasistatic and AC coercivity values lie within the expected range for Fe—Si alloys. See C. L. Cramer et al., Heliyon 5, e02804 (2019); and R. Grossinger et al., IEEE Trans. Magn. 48, 1473 (2012).

Permeability, like coercivity, is found to be strongly dependent on measurement frequency, wherein a near order-of-magnitude increase is observed in permeability for the quasistatic conditions compared to the 60-Hz frequency. Quasistatic measurements showed permeability values ranging from 9000 to 16,000 (FIG. 7c) for the annealing temperatures between 500° C. and 900° C. At 1200° C., both quasistatic samples exhibited a drop in permeability, particularly for the concentric sample condition, which decreased to a relatively modest permeability of 6000. While the precise origin for the decrease in permeability for this particular condition remains speculative, the sharp drop for the concentric condition is likely related to crack formation. The slight decrease in permeability for the cross-hatch condition may be the result of increased crystal anisotropy energy due to the coarse grain size and the presence of an unfavorable texture component, relative to the comparably finer structures observed in samples annealed between 500° C. and 900° C. (see FIGS. 3 and 4 for additional details). For example, it is possible that grains at the lower annealing temperatures may have more favorable alignment of the easy magnetization <001> crystallographic directions with respect to the applied magnetic field direction. After annealing at 1200° C., the crystallographic orientation may be such that textures with the hard <111> crystallographic directions are favored. See B. D. Cullity and C. D. Graham, Introduction to Magnetic Materials (John Wiley & Sons, Hoboken, 2011). It is noteworthy to mention that, while the texture was not measured, the magnetic flux direction is expected to continuously change direction along the B-H ring circumference, making it difficult to quantify the roles of texture and grain size on properties. Measurements at 60 Hz substantially reduced the permeability to values ranging from approximately 2000 to 4000. Notably, the permeability values were relatively consistent with respect to anneal temperature, as shown in FIG. 7c, indicating that the microstructure has a relatively minor influence on permeability at higher frequencies. Frequency-based permeability values across all annealing temperatures are higher for the concentric-built samples in comparison to the cross-hatch samples. It is likely that the permeability and other structure-sensitivity magnetic properties can be improved (i.e., become magnetically softer) if scan strategies are used that promote the alignment of the easy magnetization <001> crystallographic directions with the applied flux. In the case of the ring specimen geometry used herein, <001> textures would need to be aligned with the circumference of the ring, while a yoke-type configuration would benefit from this texture along the length of the specimen. Therefore, it may be possible to engineer textures during solidification based on anticipated flux distributions for electromagnetic devices.

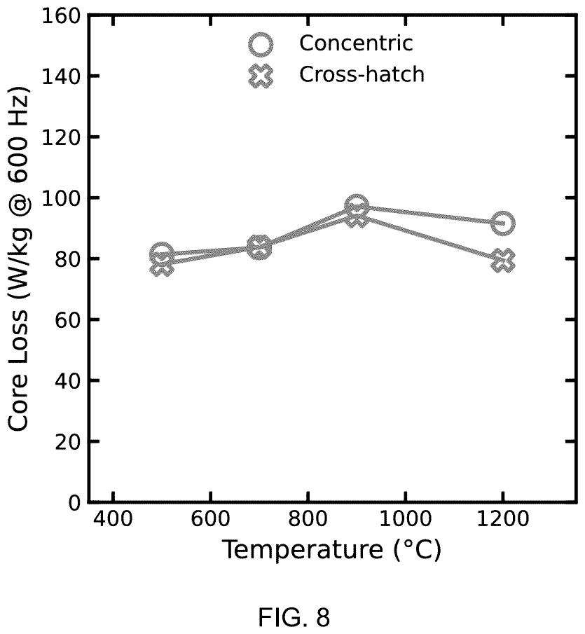

Core loss values were also extracted for the two build strategies across the full annealing range to capture compounding effects of eddy currents, hysteresis, magnetostriction, and other (anomalous) losses. In FIG. 8, concentric and cross-hatch core losses measured at 600 Hz vary slightly between 80 and 100 W/kg for all annealing temperatures. Core losses in commercial Fe—Si alloys are considerably lower despite having lower Si content, with values closer to 10 W/kg. See S. Kasai et al., JFE Tech. Rep. 21, 14 (2016). Note that 600 Hz was selected somewhat arbitrarily, but also with recognition that higher Si content enables higher frequency operation compared to lower Si alloys. One key difference is that commercial electrical steel alloys are often produced as thin-profile (0.2 mm) insulated laminates that reduce the influence of eddy current losses. Due to the bulk nature of the samples used herein, losses due to eddy currents are expected to be more pronounced and will overshadow hysteresis and magnetostrictive losses. Between 500° C. and 900° C. in FIG. 8, a slight increase in core loss is observed that could likely be the result of stronger eddy currents caused by a reduced electrical resistivity. For a given frequency, lower permeability is expected to increase efficiency; however, the relatively small changes in core loss are consistent with the frequency-based measurements in FIGS. 7a-7c. See A. M. Leary et al., JOM 64, 772 (2012). Further reduction of the core loss of this Fe—6Si alloy would require suppression of eddy currents, either by conventional lamination methods, processing of AM-enabled complex geometries that increase eddy current path lengths, or by tailoring alloy chemistry and microstructure to effectively increase the electrical resistivity. See A. Plotkowski et al., Mater. Des. 194, 108894 (2020); and A. Plotkowski et al., Addit. Manuf. 29, 100781 (2019).

### Microhardness of AM Fe—6Si Soft Magnetic Alloy

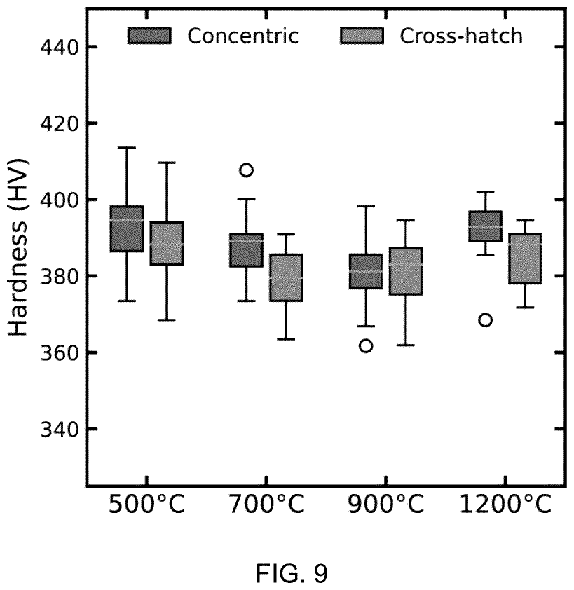

FIG. 9 shows the microhardness of concentric built and cross-hatch-built samples as a function of annealing temperature. A narrow range of high hardness values between 375-400 HV was found with no distinct correlation to the annealing temperatures nor the build strategy. While significant evolution of the microstructure was observed as a result of the heat-treatment conditions, grain sizes within the samples were relatively large in comparison to the local indent diameter; thus, dislocation motion was unimpeded by the distant grain boundaries. Notably, these data also suggest that the mechanical hardness is likely unaffected by differences in the extent of ordering (B2 or DO3 ordered lattices) that may have been achieved from the various heat treatments. Note that the heat treatments imposed herein are expected to promote the equilibrium ordered phases in Fe—Si, while as-built material may possess some degree of disorder (A2) due to the rapid solidification characteristic of LB-DED. LB-DED processing of FeCo has been previously demonstrated to suppress the extent of B2 formation. See A. B. Kustas et al., Addit. Manuf. 28, 772 (2019). Observations have been made in prior work on Fe—Si alloys wherein hardness was also found to depend more strongly on the Si concentration. See M. Komatsubara et al., J. Magn. Magn. Mater. 242, 212 (2002); and J. Shin et al., Mater. Sci. Eng. A 407, 282 (2005). Low-Si content electrical steels with 1-2 wt. % Si have modest hardness values between 150 HV and 220 HV, but at 6-6.5 wt. % the hardness is expected to be well above 350 HV, which aids in reducing magnetostriction to near-zero. See T. Omura et al., IEEE Trans. Magn. 51, 1 (20 15); M. Komatsubara et al., J. Magn. Magn. Mater. 242, 212 (2002); T. Ros et al., IEEE Trans. Magn. 37, 2321 (2001); and L. Gargalis, PhD thesis, University of Nottingham (2021). High hardness of these Fe—6Si steels will reduce magnetostrictive losses while maintaining a high saturation, leading to overall improved magnetic performance.

### Conclusions

According to the invention, LB-DED is a viable route for processing bulk forms of high-Si content electrical steels, which are traditionally too brittle to produce using conventional thermomechanical methods (e.g., rolling, forging, etc.). These results complement prior literature studies demonstrating L-PBF of high-Si alloys. See M. Garibaldi et al., Acta Mater. 110, 207 (2016); A. Plotkowski et al., Mater. Des. 194, 108894 (2020); M. Garibaldi et al., Scr. Mater. 142, 121 (2018); and J. Lemke et al., J. Alloys Compd. 722, 293 (2017). The invention enables electromagnetic device cores with intrinsically higher efficiency than those currently in use. Conventional electromagnetic device cores often consist of stacked laminated magnetic sheets, where the sheet thickness in combination with surface insulation (i.e., non-conductive coating) reduces losses (eddy currents) and improves energy efficiency compared to bulk core designs. Therefore, AM-processed electrical steel components may require integration of both advanced designs, in addition to unconventional alloy compositions, to increase device efficiency and justify widespread adoption over conventional laminated sheet. Prior studies have shown that L-PBF can effectively produce complex designs that reduce eddy current losses compared to bulk material, such as through a Hilbert-type curve. See A. Plotkowski et al., Mater. Des. 194, 108894 (2020). However, integration of insulating layers on the component surfaces during manufacturing remains a challenge with this modality. Furthermore, LB-DED generally cannot access the same extent of part resolution and geometric control as other AM methods, like L-PBF, particularly when designed with overhang features and thin-wall struts/lattices. Thus, the extent of eddy current reduction through advanced component design that is possible when using existing LB-DED approaches may be limited compared to conventional thin-profile laminated sheet or L-PBF-enabled designs. Finally, LB-DED-processed material showed evidence of cracking, which was increasingly pronounced with heat treatment. Such defects are unacceptable in electromagnetic cores and represent another consideration for AM-processed electrical steels. Despite these concerns, it is noteworthy to emphasize that, unlike most L-PBF systems and conventional manufacturing approaches, LB-DED can readily integrate multiple material configurations with high spatial precision in a single part architecture. Thus, processing of conductive (i.e., electrical steel) and non-conductive materials in an alternating layer-wise manner can offer opportunities to offset geometry limitations and improve device efficiency, more closely approaching conventional stacked laminations. For example, non-conductive materials can include a thermal grown native oxide layer, or a ceramic, ferrite (magnetic oxide), or semiconductive layer (e.g., Si) printed on the conductive layer. Furthermore, LB-DED methods can similarly integrate various combinations of alloys to enable control of part mechanical-magnetic property relationships. One example is integration of high-strength alloys in high-stress regions of stator/rotor designs for electric motors, where the high-strength alloy enables higher motor speeds compared to monolithic magnetic alloy sheets that are currently limited by the alloy mechanical properties. See S. Firdosy et al., Scr. Mater. 202, 114005 (2021); and F. Guo et al., IEEE Trans. Ind. Appl. 56, 3656 (2020).

The present invention has been described as high silicon electrical steel alloys using directed energy deposition. It will be understood that the above description is merely illustrative of the applications of the principles of the present invention, the scope of which is to be determined by the claims viewed in light of the specification. Other variants and modifications of the invention will be apparent to those of skill in the art.

1. A method for laser-beam directed energy deposition of a high-silicon electric steel part, comprising
depositing a powder stream of a high-silicon content Fe—Si alloy on a substrate,
simultaneously melting or sintering the deposited powder using a focused laser beam coincident with the powder stream,
scanning the coincident laser/powder streams relative to the substrate according to a scan strategy to print a layer, and
building the three-dimensional high-silicon electric steel part via layer-by-layer printing of successive layers of high-silicon content Fe—Si alloy.

2. The method of claim 1, wherein the high-silicon content Fe—Si alloy comprises greater than 4 wt. % silicon.

3. The method of claim 2, wherein the high-silicon content Fe—Si alloy comprises greater than 6 wt. % silicon.

4. The method of claim 1, further comprising heat treating the three-dimensional high-silicon electric steel part at an annealing temperature.

5. The method of claim 4, wherein the annealing temperature is greater than 500° C., to at least partially recrystallize a microstructure of the three-dimensional high-silicon electric steel part.

6. The method of claim 5, wherein the annealing temperature is greater than 700° C., thereby providing a chemically ordered B2 microstructure.

7. The method of claim 5, wherein the annealing temperature is greater than 900° C., thereby providing a chemically disordered BCC microstructure.

8. The method of claim 1, wherein the scan strategy is configured to minimize residual stresses in the three-dimensional high-silicon electric steel part.

9. The method of claim 1, wherein the scan strategy comprises a cross-hatch laser scan strategy.

10. The method of claim 1, wherein the scan strategy comprises a concentric laser scan strategy.

11. The method of claim 1, wherein the high-silicon electric steel has a hardness greater than 360 HV.

12. The method of claim 1, wherein the high-silicon electric steel has a coercivity less than 50 A/m.

13. The method of claim 1, wherein the high-silicon electric steel has a saturation magnetization greater than 1.5 Tesla.

14. The method of claim 1, wherein the three-dimensional part comprises an electromagnetic device core.

15. The method of claim 1, further comprising printing a layer of non-conductive material between successive layers of high-silicon content Fe—Si alloy to provide a stacked lamination.
